(19) United States
(12) Patent Application Publication
(10) Pub. No.: US 2025/0385507 A1
(43) Pub. Date: Dec. 18, 2025

(54) METHOD OF CONTROLLING AN ELECTRICAL PROTECTION DEVICE, ASSOCIATED DEVICE AND INSTALLATION

(71) Applicant: Schneider Electric Industries SAS, Rueil-Malmaison (FR)

(72) Inventor: Sébastien Heraud, Grenoble (FR)

(73) Assignee: Schneider Electric Industries SAS, Rueil-Malmaison (FR)

(21) Appl. No.: 19/234,685

(22) Filed: Jun. 11, 2025

(30) Foreign Application Priority Data
Jun. 17, 2024 (FR) 2406441

(51) Int. Cl. H02H 3/08; H02H 1/00; H02H 9/04

(52) U.S. Cl. CPC H02H 3/08; H02H 1/0007; H02H 9/04

(57) ABSTRACT

The present invention relates to a method of controlling an electrical protection device. When an electrical fault of the short-circuit type is detected during a step b) and when the tripping energy is greater than or equal to the tripping energy threshold in step d), controlling (S118) each switching module to enter the off-configuration. When the reclosing time of the given circuit breaker has elapsed, controlling (S122) each switching module to enter the on-configuration. If a circuit breaker is connected immediately upstream of the given circuit breaker, a test duration (T₁) has not elapsed and a short-circuit is detected, performing steps c) to f) again; and if no circuit-breaker is connected immediately upstream of the given circuit-breaker, the test duration (T₁) has not elapsed and a short-circuit is detected, controlling (S138) each switching module in the off-configuration.

### FIELD

This invention relates to a method of controlling an electrical protection device, and an associated electrical protection device and installation.

### BACKGROUND

In an electrical installation, one or more protection devices are known to be connected between a source and a load. The protection device protects the cables. It is therefore common to find several electromechanical protection devices of different ratings in series, each capable of protecting different sections of cable, from the largest section connected to the source to the smallest connected to the load. The protection device located at the top may be, for example, a hybrid or static circuit breaker associated with one or more downstream electromechanical circuit breaker(s). To ensure that the electromechanical circuit breakers trip, it is necessary to delay a tripping of the protection device, so that the electromechanical circuit breaker has received sufficient energy to be tripped.

It is also possible to connect two electromechanical circuit breakers in series, with the downstream circuit breaker having a lower rating than the upstream circuit breaker. To protect the installation and prevent damage to the furthest downstream circuit breaker, the tripping threshold of the upstream circuit breaker must be less than or equal to the rating of the downstream circuit breaker. A current interruption in the event of a short-circuit type electrical fault therefore depends on a single tripping threshold. However, in order to protect all the cable sections in an installation, it may be necessary to connect a plurality of electromechanical circuit breakers with different ratings, and to ensure a plurality of tripping thresholds.

### SUMMARY

The aim of the invention is therefore to propose a method for ensuring selective tripping of a plurality of electromechanical circuit breakers with different ratings.

To this end, the subject matter of the invention is a method of controlling an electrical protection device, configured to be connected between a source and a series of circuit breakers, the device comprising:
an interruption cell, comprising at least one switching module, each switching module comprising:
   at least one semiconductor element; and
   a limiting element, connected in parallel with the at least one semiconductor element, the limiting element having a limiting voltage, the limiting voltage or voltages, alone and/or summed together, forming one or a plurality of distinct levels, each switching module being configured to switch between a on-configuration, wherein a current flowing between the source and the series of circuit breakers flows in the or in one of the semiconductor elements, and a off-configuration, wherein if the current flows in the switching module, it flows within the limiting element;
a current sensor, configured to measure an intensity and/or derivative of the current;
a control unit comprising a processing module, and a cell control module, configured to control each switching module in the on-configuration and in the off-configuration,
   each circuit breaker in the series being configured to switch between an armed configuration and a tripped configuration, each circuit breaker in the series being associated with a fault current threshold, a tripping energy threshold and a reclosing time, the circuit breakers being connected in series with one another and arranged from upstream to downstream in decreasing order of their respective fault current threshold.

the method comprising at least the following steps:
a) measuring the current intensity and/or the derivative thereof as a function of time using the current sensor;
b) detecting an electrical fault of the short-circuit type by the processing module, if the intensity measured by the current sensor is strictly greater than the fault current threshold and/or the derivative measured by the current sensor is strictly greater than a fault derivative threshold of a given circuit breaker, the given circuit breaker being the circuit breaker in armed configuration furthest downstream in the series of circuit breakers;
c) when a short-circuit type electrical fault is detected, waiting until the tripping energy becomes greater than or equal to a given circuit-breaker tripping energy threshold;
d) when the tripping energy is greater than or equal to the tripping energy threshold of the given circuit breaker, the cell control module controlling each switching module to enter the off-configuration;
e) when the reclosing time of the given circuit breaker has elapsed, the given circuit breaker having switched to the tripped configuration, controlling each switching module to enter the on-configuration, whereas each switching module was controlled to enter the off-configuration in step d);
f) if a circuit-breaker is connected immediately upstream of the given circuit-breaker, if a test duration has not elapsed and if a short-circuit is detected, the fault current threshold, the tripping energy threshold and the reclosing time being those of the circuit-breaker in the armed configuration immediately upstream of the given circuit-breaker, carrying out steps c) to f) again; and
g) if no circuit-breaker is connected immediately upstream of the given circuit-breaker, if the test duration has not elapsed and if a short-circuit is detected, with the fault current threshold equal to a final fault current threshold, controlling each switching module to enter the off-configuration.

Thanks to the invention, it is possible to trip the circuit breakers successively, from the furthest-downstream circuit breaker, i.e. the one closest to the load, to the furthest-upstream circuit breaker, i.e. the one closest to the source. In this way, it is possible to obtain different fault current thresholds for different circuit breakers in the circuit breaker series, allowing the current to be interrupted only for those circuit breakers downstream of the fault by means of a single protection device, while leaving those upstream of the fault armed and operating normally. This limits the interruption of power to loads connected upstream of the electrical fault.

In addition, by waiting for the tripping energy to reach the tripping energy threshold before controlling the switching modules to enter the off-configuration, the control method makes it possible to limit the current and energy flowing between the source and the load to the minimum necessary to trip the furthest-upstream armed circuit breaker, while ensuring that the latter trips. This limits electrical and thermal stress in the installation and in the cables.

In other beneficial aspects of the invention, the method comprises one or more of the following features, taken in isolation or in any technically possible combination:
The method further comprises the following successive steps:
h) the processing module detecting an electrical fault of the short-circuit type, if the intensity measured by the current sensor in step a) is strictly greater than a transient fault current threshold and/or the derivative measured by the current sensor in step a) is strictly greater than a fault derivative threshold;
i) the cell control module controlling each switching module to enter the off-configuration if an electrical fault is detected in step h);
j) when a transient fault reclosing time has elapsed, controlling each switching module to enter the on-configuration; and
k) if the test duration has not elapsed, carrying out steps b) to g), the given circuit-breaker being the circuit-breaker in the armed configuration that is connected furthest downstream.
The method further comprises the following step:
l) when an electrical fault of the short-circuit type is detected by the processing module, controlling a mechanical switch, connected in parallel with the interruption cell, to enter an open configuration, the mechanical switch being configured to switch between a closed configuration, wherein the mechanical switch conducts the current, and an open configuration, wherein the mechanical switch does not conduct the current, by a mechanical switch control module included in the control unit.
while step i) is performed when a dielectric strength of the mechanical switch is greater than a sum of the limiting voltage of the limiting element of each switching module.
If the test duration has elapsed and a short-circuit is not detected, controlling the mechanical switch to enter the closed configuration.
This method further comprises the following step:
m) if the test duration has elapsed, and the intensity is strictly greater than a transient fault current threshold and/or the derivative measured by the current sensor is strictly greater than a fault derivative threshold, controlling each switching module to enter the off-configuration.
Each circuit breaker is further associated with a minimum intensity threshold and a maximum intensity threshold and wherein step c) further comprises the following sub-steps:
   c1) when an electrical fault of the short-circuit type is detected by the processing module in step b), the tripping energy is less than or equal to the tripping energy threshold of the given circuit breaker, and the intensity measured by the current sensor is less than or equal to the minimum intensity threshold, the cell control module controls the one or more switching modules whose limiting elements' limiting voltages form a clipping level to enter the on-configuration, the clipping level being the lowest level above a nominal mains voltage; and
   c2) when an electrical fault of the short-circuit type is detected by the processing module in step b), the tripping energy is less than or equal to the tripping energy threshold of the given circuit breaker, and the intensity measured by the current sensor reaches the maximum intensity threshold, the cell control module controls the one or more switching modules whose limiting elements' limiting voltages form the clipping level to enter the off-configuration.
The device comprises a plurality of switching modules, connected to each other, sub-step c2) further comprises the cell control module controlling the switching modules whose limiting elements' limiting voltages do not form the clipping level to enter the on-configuration.

The invention also relates to an electrical protection device configured to be connected between a source and a series of circuit breakers, each circuit breaker in the series being configured to switch between an armed configuration and a tripped configuration, each circuit breaker in the series being associated with a fault current threshold, a tripping energy threshold and a reclosing time, the circuit breakers being configured to be connected in series with one another and arranged from upstream to downstream in decreasing order of their respective fault current threshold, the device comprising:
an interruption cell, comprising at least one switching module, each switching module comprising:
   at least one semiconductor element; and
   a limiting element, connected in parallel with the at least one semiconductor element, the limiting element having a limiting voltage, the limiting voltage or voltages, alone and/or summed together, forming one or a plurality of distinct levels, each switching module being configured to switch between a on-configuration, wherein a current flowing between the source and the series of circuit breakers flows in the or in one of the semiconductor elements, and a off-configuration, wherein if the current flows in the switching module, it flows within the limiting element;
a current sensor, configured to measure an intensity of the current and/or derivative of the current;
a control unit comprising:
   a processing module configured to detect an electrical fault of the short-circuit type as a function of the intensity and/or derivative measured by the current sensor; and
   a cell control module, configured to control each switching module in the on-configuration and in the off-configuration, the device being configured to implement the method described above.

Advantageously, this device comprises a single switching module, the limiting voltage of the voltage limiting element of the switching module then forming the clipping level.

The invention also relates to an electrical installation comprising a source, a load, a series of circuit breakers connected between the source and the load, each circuit breaker in the series being configured to switch between an armed configuration and a tripped configuration, each circuit breaker in the series being associated with a fault current threshold, a tripping energy threshold and a reclosing time, the circuit breakers being connected in series with one another and arranged from upstream to downstream in decreasing order of their respective fault current threshold, and a device as previously described, connected between the source and the series of circuit breakers.

### BRIEF DESCRIPTION OF THE DRAWINGS

The invention will appear more clearly when reading the description that follows, given solely as a non-limiting example and made in reference to drawings in which:

FIG. 1 is an electrical schematic of an electrical installation according to the invention;

FIG. 2 is an electrical schematic of an electrical protection device according to a first embodiment of the invention;

FIG. 3 is a plot of characteristic variables of the device shown in FIG. 2, as a function of time;

FIG. 4 is a detailed view of inset IV in FIG. 3;

FIG. 5 is a flowchart of a method of controlling the device belonging shown in FIG. 3, in accordance with the invention;

FIG. 6 is an electrical schematic of an electrical protection device according to a second embodiment of the invention;

FIG. 7 is an electrical schematic of an interruption cell of the device shown in FIG. 6;

FIG. 8 is a plot of characteristic variables of the device shown in FIG. 6, as a function of time;

FIG. 9 is a detailed view of inset X in FIG. 8;

FIG. 10 is a flowchart of a method of controlling the device belonging shown in FIG. 6, in accordance with the invention; and

FIG. 11 is an electrical schematic of an interruption cell belonging to an electrical protection device according to a third embodiment of the invention.

### DETAILED DESCRIPTION

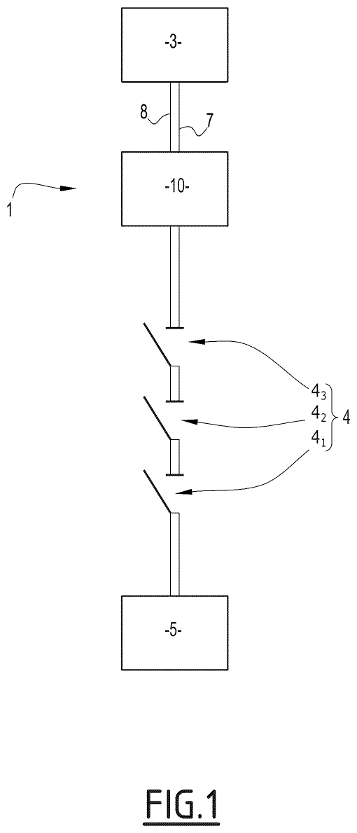

FIG. 1 is a diagram of an electrical installation 1 comprising a source 3, a series of circuit breakers 4 and a load 5, electrically interconnected by a phase conductor 7 and a neutral conductor 8.

The source 3 supplies electricity and is, for example, an electrical generator or an electrical network, for example a mains electrical network.

The load 5 is a device that consumes electricity, such as a domestic electrical appliance, industrial equipment such as an electric motor, or a server. In this way, an electric current, referred to hereafter simply as current, flows between the source 3 and the load 5 through the phase conductor 7, and returns to the source 3 through the neutral conductor 8.

The current is a low-voltage or medium-voltage current, i.e. the nominal voltage Uₛ of the current, also known as the mains voltage or nominal network voltage, is less than 52,000 V. The current is an alternating current or, alternatively, a direct current.

The series of circuit breakers 4 is connected between the source 3 and the load 5. The series of circuit breakers 4 comprises a plurality of circuit breakers, in this case three circuit breakers 4₁, 4₂ and 4₃.

In the example shown in FIG. 1, circuit breaker 4₁ is the most downstream circuit breaker, i.e. the one closest to load 5. The circuit breaker 4₃ is the most upstream circuit breaker, i.e. the one closest to the source 3. The circuit breaker 4₂ is the intermediate circuit-breaker, i.e. the circuit-breaker located between the upstream and downstream circuit-breakers.

Each circuit breaker 4₁, 4₂, 4₃ is configured to switch between an armed configuration, in which it conducts electrical current, and a tripped configuration, in which it does not conduct electrical current. Each circuit breaker 4₁, 4₂, 4₃ is associated with a distinct fault current threshold, I₁, I₂, I₃, respectively, and a reclosing time, Tᵣ₁, Tᵣ₂ and Tᵣ₃ respectively. The circuit breakers 4₁, 4₂ and 4₃ are connected in series with each other so as to be arranged from upstream to downstream in decreasing order of their respective fault current threshold. In the example shown in FIG. 1, the fault current threshold I₃ is higher than the fault current threshold I₂, which is itself higher than the fault current threshold I₁.

The series of circuit breakers 4 comprises at least two circuit breakers with different fault thresholds.

In a variant not shown, the fault current thresholds of two adjacent circuit breakers may be equal.

The circuit breakers 4₁, 4₂ and 4₃ are electromechanical circuit breakers or static circuit breakers. In the example shown in FIG. 1, circuit breakers 4₁, 4₂ and 4₃ are all electromechanical circuit breakers. Each electromechanical circuit breaker 4₁, 4₂, 4₃ is configured to trip and interrupt the current flowing from the source 3 to the load 5 when a short-circuit type electrical fault, hereinafter referred to as a short-circuit, is present in the electrical installation 1. Each electromechanical circuit breaker 4₁, 4₂, 4₃ comprises contacts and a trip device which may be a coil, a magnetic vane, an electronic or electromechanical device, not shown, which, when it receives sufficient energy, is responsible for separating the contacts.

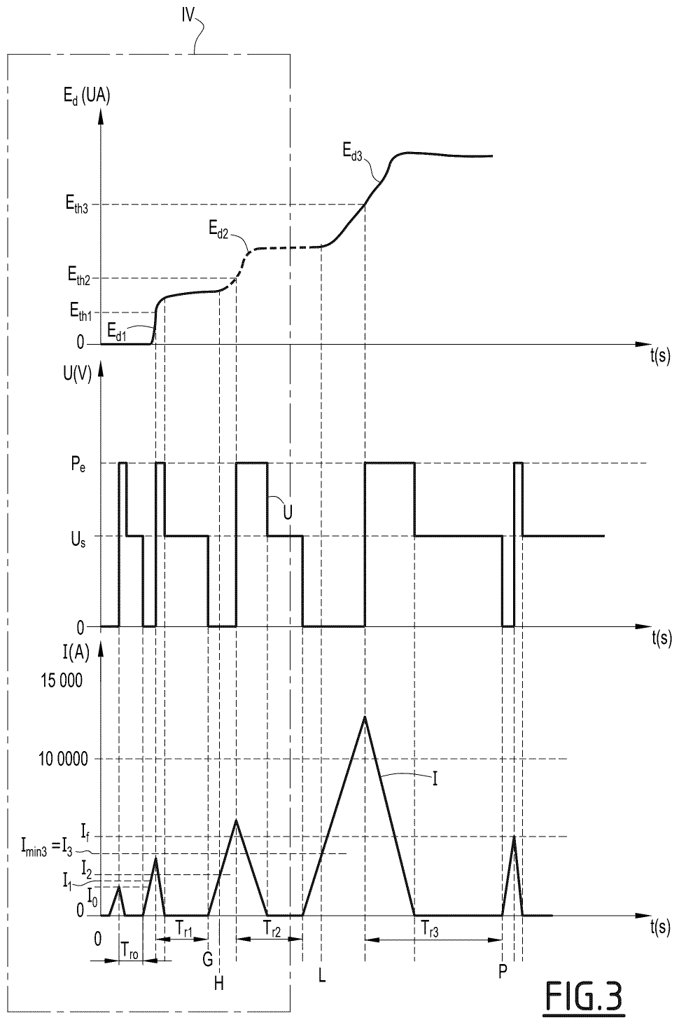

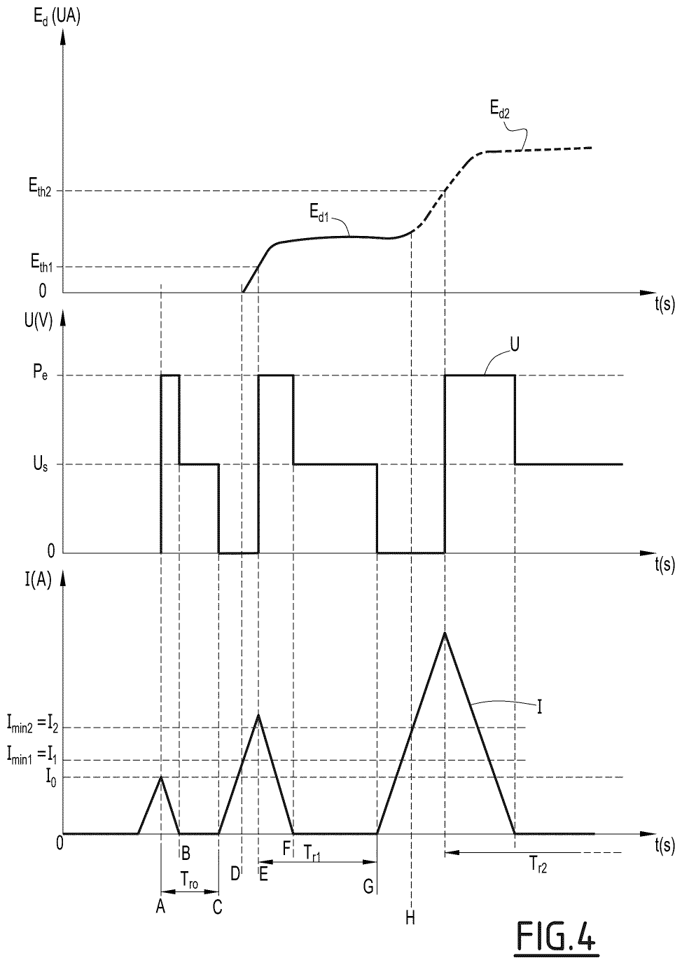

More specifically, when a short-circuit is present in the electrical installation 1, an intensity I of the current flowing between the source 3 and the load 5, expressed in amperes (A) in FIGS. 3 and 4, increases rapidly and significantly, for example by several tens of amperes per microsecond. Each circuit breaker 4₁, 4₂, 4₃, is associated with a tripping energy threshold, Eₜₕ₁, Eₜₕ₂ and Eₜₕ₃ respectively. When the circuit breaker 4₁ receives a tripping energy E_{d1} equal to or greater than the tripping energy threshold Eₜₕ₁, the release of the circuit breaker 4₁ causes the contacts of the electromechanical circuit breaker 4₁ to open and interrupts the current between the source 3 and the load 5, more precisely between the device 10 and the load 5. In other words, when the tripping energy E_{d1} is greater than or equal to the energy threshold Eₜₕ₁, the electromechanical circuit breaker 4₁ trips. The tripping energy E_{d1} is a function of time t and intensity I and is only received when the intensity I is strictly greater than a minimum intensity Iₘᵢₙ₁.

The same applies to circuit-breakers 4₂ and 4₃, which trip when they have respectively received a tripping energy E_{d2} and E_{d3} greater than or equal to the tripping energy threshold Eₜₕ₂ and Eₜₕ₃. The tripping energy E_{d2} is only received when the intensity I is strictly greater than a minimum intensity Iₘᵢₙ₂ and the tripping energy E_{d3} is only received when the intensity I is strictly greater than a minimum intensity Iₘᵢₙ₃.

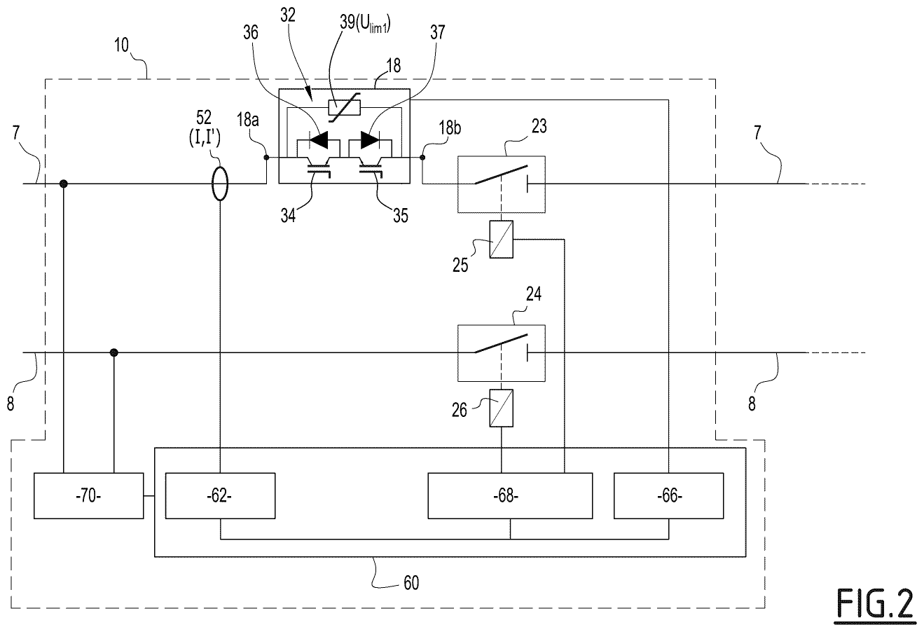

The tripping energy E_{d1} is less than the tripping energy E_{d2}, which in turn is less than the tripping energy E_{d3}. Tripping energies are expressed in arbitrary units (AU). The electrical installation 1 further comprises an electrical protection device 10, hereinafter further referred to as the device, connected between the source 3 and the series of circuit breakers 4. The device 10 is detailed in FIG. 2. The device 10 is configured to switch between an armed configuration, wherein the device 10 conducts the current flowing between the source 3 and the series of circuit breakers 4, and a tripped configuration, wherein the device 10 electrically isolates the source 3 from the series of circuit breakers 4. The device 10 has a voltage U, expressed in volts (V), applied across its terminals, between the conductors 7 and 8.

In the embodiment shown in FIGS. 1 to 4, the device 10 is a solid state circuit breaker (SSCB). It comprises an interruption cell 18 connected in series to the phase conductor 7 via an input 18a and an output 18b.

The interruption cell 18 is configured to allow or interrupt the current flowing through it, as explained later.

The device 10 advantageously comprises a first disconnector 23 and, optionally, a second disconnector 24, connected respectively to the phase conductor 7 and the neutral conductor 8. In particular, the disconnector 23 is connected to the phase conductor 7 in series with the interruption cell 18. The disconnector 24 is connected in series with the neutral conductor 8. The disconnectors 23 and 24 are configured to switch between a closed configuration, wherein the disconnectors 23 and 24 conduct current, and an open configuration, wherein the disconnectors 23 and 24 do not conduct current. Advantageously, and as shown in FIG. 2, the device 10 comprises an actuator 25 of the first disconnector 23 and an actuator 26 of the second disconnector 24 which, when activated, interact respectively with the first disconnector 23 and the second disconnector 24 to cause them to switch to the open configuration. The actuators 25 and 26 are, for example, coils and are activated when a current flows through the turns of the coils.

The disconnectors 23 and 24 are configured to switch to the open position in particular when no current is flowing between the source 3 and the load 5; in other words, when the current has been interrupted by the interruption cell 18.

The interruption cell 18 comprises at least one switching module, in this case a single switching module 32. The switching module 32 comprises at least one semiconductor element controllable in switching, for example at least one thyristor or at least one transistor, such as a field effect transistor, also known as a FET (Field Effect Transistor), an insulated gate field effect transistor, also known as a MOSFET (Metal Oxide Semiconductor Field Effect Transistor) transistor, also known as a MOSFET (Metal Oxide Semiconductor Field Effect Transistor), an insulated gate bipolar transistor, also known as an IGBT (Insulated Gate Bipolar Transistor), or a combination of these different semiconductor elements. In the embodiment shown in FIG. 2, the interrupter cell 18 comprises two semiconductor elements 34 and 35. The semiconductor elements 34 and 35 are unidirectional in current and are, for example, two IGBT type transistors. The conduction direction of transistors 34 and 35 is indicated by an arrow on each transistor 34, 35. The transistors 34 and 35 are connected to one another in series with opposite orientations, i.e. transistors 34 and 35 are connected in anti-series, so that they do not conduct current at the same time. Two diodes 36 and 37 are connected to transistors 34 and 35 respectively. The diode 36 is connected to the transistor 34 in parallel with opposite orientations, i.e. the diode 36 and transistor 34 do not conduct current at the same time: if the transistor 34 is conducting, the diode 36 is blocked and vice versa. In other words, the transistor 34 and the diode 36 are connected in parallel but with opposing orientations. The same applies to the transistor 35 and diode 37. This arrangement enables the switching module 32 to conduct alternating current uninterrupted whenever the sign of the current changes.

The switching module 32 comprises a voltage limiting element 39, also known as a limiting element. The voltage-limiting element 39 is connected in parallel with an assembly formed by the transistors 34 and 35, and is for example a metal oxide varistor (MOV), a transil diode or a gas spark gap. The voltage-limiting element 39 has a limiting voltage Uₗᵢₘ₁, which corresponds to a voltage across its terminals when the current flowing between the source 3 and the load 5 passes through it. The limiting voltage Uₗᵢₘ₁ is higher than the nominal mains voltage Uₛ, for example by about 1.5 times the nominal mains voltage Uₛ. The limiting voltage Uₗᵢₘ₁ forms a clipping level Pe, which is thus higher than the nominal mains voltage Uₛ.

The switching module 32 is configured to switch between an on-configuration and a off-configuration. In the on-configuration, the current flows through one of the transistors 34 or 35. More specifically, when the current flowing through device 10 is alternating, the current flows through the transistor 34 and diode 37, then when the current changes direction, through the transistor 35 and diode 36.

In the off-configuration, the transistors 34 and 35 do not conduct current and, if current flows in the switching module 32, it flows through the voltage-limiting element 39.

Thus, in the off-configuration, a voltage across the switching module 32 is the limiting voltage Uₗᵢₘ₁. This voltage across the switching module 32 is then also the voltage U across the device 10. In other words, a counter-voltage whose value is that of the limiting voltage Uₗᵢₘ₁ is applied across the terminals of the device 10.

The control device 10 further comprises a current sensor 52. The current sensor 52 is configured to measure an intensity I of the current and/or a derivative of the current flowing between the source 3 and the load 5, and in particular the current flowing in the phase conductor 7. The current sensor 52 is, for example, a Rogowski coil.

The control device 10 further comprises a control unit 60, comprising a processing module 62, connected to the current sensor 52 and configured to detect an electrical fault of the short-circuit type as a function of the intensity I, measured by the current sensor 52.

The control unit 60 further comprises a cell control module 66 and, advantageously, a disconnector control module 68, connected to the processing module 62 and respectively configured to control the interruption cell 18, more precisely the switching module 32, and the disconnectors 23 and 24.

The cell control module 66, also known as the control module, is configured to control the switching module 32 in the on-configuration and in the off-configuration, as explained in more detail later, in particular by actuating the gate of the transistors 34 and 35.

The disconnector control module 68 is advantageously configured to operate the actuators 25 and 26 respectively, in order to switch the disconnectors 23 and 24 to the open configuration.

The control unit 60 is an electronic circuit designed to manipulate and/or transform data represented as electronic or physical quantities in registers of the control unit 60 and/or memories into other similar data corresponding to physical data in memories, registers or other types of display devices, transmission devices or storage devices.

As specific examples, the control unit 60 is in the form of a programmable logical component, such as a FPGA (Field Programmable Gate Array), or in the form a dedicated integrated circuit, such as an ASIC (Application-Specific Integrated Circuit).

In a variant not shown, the control unit 60 comprises an information processing unit formed for example by a memory and a processor associated with the memory. The processing module 62, the cell control module 66, and the disconnector control module 68 are each in the form of software, or a software brick, which can be executed by the processor. The memory of the control unit 60 is then able to store processing software, cell control software and disconnector control software. The processor is then able to run each of the processing software, cell control software and disconnector control software.

In a variant not shown, the processing module 62, the cell control module 66, and the disconnector control module 68 are each in the form of a programmable logical component, such as a FPGA, or an integrated circuit, such as an ASIC.

Advantageously, the device 10 further comprises a power supply module 70, connected to the conductors 7 and 8 and to the control unit 60, in order to supply the control unit 60 with electricity. Alternatively, the power supply module 70 is connected to an external circuit, not connected to the conductors 7 and 8.

A method for controlling the device 10 in accordance with the invention will now be explained, with reference to FIGS. 3 to 5.

Advantageously, the device 10 is initially in the armed configuration, i.e. the disconnectors 23 and 24 are in the closed configuration and the switching module 32 is in the open configuration. Current flows from the source 3 to the mechanical circuit breaker 4, via the switching module 32. The voltage U across the device 10 is zero, or substantially zero. All the circuit breakers 4₁, 4₂ and 4₃ are in the armed configuration and are conducting current.

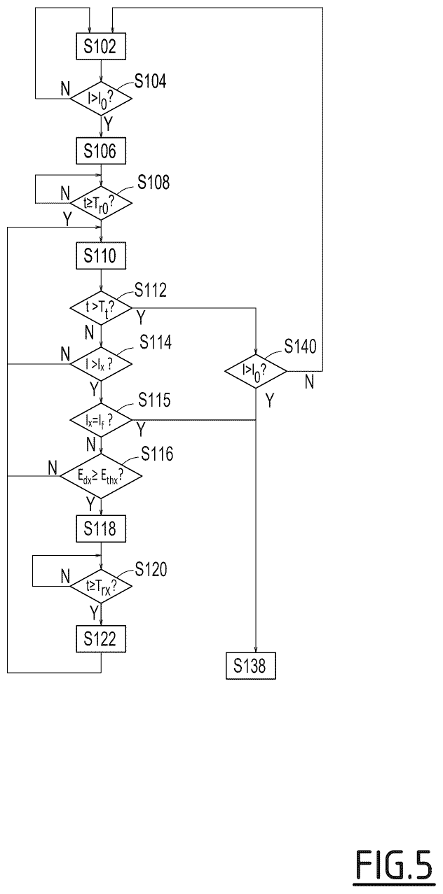

The current sensor 52 measures the intensity I of the current and/or the derivative I′ of the intensity I flowing in the phase conductor 7, in step S102 of the method shown in FIG. 5.

In order to distinguish a short-circuit from a transient fault, which can also cause a sudden and significant increase in the current intensity I, caused for example by a key being dropped on a busbar, or by a short-lived malfunction which disappears by itself in a few hundred microseconds, the control method advantageously comprises steps S104 to S112.

The control unit 60 receives the measurement of the intensity I and/or derivative of the intensity and detects, in step S104 and via the processing module 62, whether an electrical fault, corresponding to a short-circuit potential, is present between the source 3 and the load 5. To do this, the processing module 62 compares the measured intensity I with a transient fault current threshold I₀. If the intensity I is less than or equal to the transient fault current threshold I₀, the current sensor 52 performs step S102 again and continues to measure the intensity I. An iterative process is then implemented.

If the intensity I is strictly greater than the transient fault current threshold I₀, then the cell control module 66 controls each switching module, in this case the single switching module 32, to enter the off-configuration in step S106, as can be seen in FIG. 4, at time A. The voltage U becomes equal to the clipping level Pe and the intensity I decreases until it becomes zero at time B. When the intensity I becomes zero, the voltage U across the device 10 becomes equal to the nominal mains voltage Uₛ.

Alternatively, not shown, in step S106, the cell control module 66 controls each switching module, in this case the single switching module 32, in an off-configuration when the derivative I′ of the intensity I as a function of time t is strictly greater than a predetermined fault derivative threshold, or else if a combination of conditions regarding the intensity I and its derivative I′ are met, for example the intensity I and its derivative I′ are strictly greater than the transient fault current threshold I₀ and the derivative of the intensity I is strictly greater than the fault derivative threshold.

In step S108, the control unit 60 waits until the transient fault reclosing time Tᵣ₀, counted from the moment when the cell control module 66 controls the switching module 32 to enter the off-configuration, has elapsed. The reclosing time of the transient fault Tᵣ₀ is advantageously predetermined and programmed in advance by the manufacturer of the device 10. It is, for example, less than or equal to 500 μs.

When the reclosing time of the transient fault Tᵣ₀ has elapsed, the switching module 66 performs step S110 in which it controls each switching module, in this case the switching module 32, to enter the on-configuration at a time C. The current therefore flows again between the source 3 and the load 5 and the voltage U becomes zero. This setting of the module 32 to the on-configuration is used to test whether the fault detected in step S104 has disappeared or whether it is still present.

The processing module 62 determines whether a test duration T₁, measured from time C, has elapsed in step S112. If the test duration T₁ has not elapsed, the processing module 62 considers, in step S114, that a short-circuit has been detected if the intensity I of the current as measured by the current sensor 52 is strictly greater than the fault current threshold I₁ of the circuit breaker 4₁, which is the circuit breaker of the series of circuit breakers 4 in the armed configuration furthest downstream.

Alternatively, the short circuit is considered to be detected in step S114 if the derivative I′ of the intensity I is strictly greater than a predetermined threshold, or if a combination of conditions regarding the intensity I and its derivative are met, for example the intensity I is strictly greater than the fault current threshold I₁ and the derivative I′ of the intensity I is strictly greater than the predetermined threshold.

If the intensity I of the current as measured by the current sensor 52 is less than or equal to the fault current threshold I₁ of the circuit breaker 4₁, the processing module 62 performs step S112 again. An iterative process is then implemented.

If the test duration T₁ has elapsed without the intensity I having become strictly greater than the fault current threshold I₁, then the electrical fault detected in step S104 was a transient fault. The method is restarted and the device 10 performs step S102 again. An iterative process is then implemented.

If the intensity I of the current as measured by the current sensor 52 in step S114 is strictly greater than the fault current threshold I₁ of the circuit breaker 4₁, as represented at a time D in FIG. 4, then the control unit 60 determines that the fault current threshold I₁ μsed in step S114 is different from a fault current threshold I₂ in a step S115. The control unit 60 then estimates the tripping energy E_{d1} and compares it with the tripping energy threshold Eₜₕ₁ in step S116. Advantageously, the tripping energy E_{d1} is estimated only when the intensity I is strictly greater than the minimum intensity Iₘᵢₙ₁. Advantageously, as shown in FIGS. 3 and 4, the minimum intensity Iₘᵢₙ₁ is equal to the tripping threshold I₁. If the tripping energy E_{d1} is less than the tripping energy threshold Eₜₕ₁, then the control unit 60 performs step S112 again and iterative process is implemented. If the tripping energy E_{d1} is greater than or equal to the tripping energy threshold Eₜₕ₁, which is the case at time E in FIG. 4, then circuit breaker 4₁ trips, and if the fault is downstream of circuit breaker 4₁, isolates the fault. The cell control module 66 then controls the switching module 32 to enter the off-configuration in step S118, visible at time G in FIG. 4. The voltage U becomes equal to the clipping level Pe and the intensity I decreases until it becomes practically zero at a time F. When the intensity I becomes zero, the voltage U becomes equal to the nominal network voltage Uₛ.

The control unit 60 waits for a reclosing time Tᵣ₁, measured from time E, to elapse in step S120. The reclosing time Tᵣ₁ is advantageously predetermined and programmed in advance by the manufacturer of the device 10.

When the reclosing time Tᵣ₁ has elapsed, the cell control module 66 controls the module 32 to enter the on-configuration in step S122, corresponding to a time G in FIG. 4. The current therefore flows again between source 3 and circuit breaker 4₂, circuit breaker 4₁ has been tripped if the fault was downstream of the latter, and the voltage U across device 10 becomes zero. This setting of the module 32 to the on-configuration is used to test whether the fault detected in step S114 has disappeared, i.e. whether the fault was located between the circuit breaker 4₁ and the load 5, or whether the fault is still present and is therefore located on the upstream side of the circuit breaker 4₁.

The circuit breaker 4₂ being connected immediately upstream of the circuit breaker 4₁, the processing module 62 then performs a second iteration of steps S112 to S122, the fault current threshold, the tripping energy threshold and the reclosing time used in the rest of the process described below become those associated with the circuit breaker 4₂, which is the circuit breaker in armed configuration immediately upstream of circuit breaker 4₁, i.e. the fault current threshold I₂, the tripping energy threshold Eₜₕ₂, and the reclosing time Tᵣ₂. The circuit breaker 4₂ is the new circuit breaker in the series of circuit breakers 4 in armed configuration and connected furthest downstream.

The processing module 62 determines in step 112 whether the test duration T₁, measured from time C, has elapsed in step S112. If the test duration T₁ has not elapsed, the processing module 62 detects in step S114 whether the intensity I of the current as measured by the current sensor 52 is less than, equal to or strictly greater than the fault current threshold I₂ of the circuit breaker 4₂, in other words, whether the short-circuit is still present.

If the intensity I of the current as measured by the current sensor 52 is less than or equal to the fault current threshold I₂ of the circuit breaker 4₂, the processing module 62 performs step S112 again, and an iterative process is then implemented.

If the intensity I measured by the current sensor 52 is detected in step S114 as being strictly greater than the fault current threshold I₂ of circuit breaker 4₂, which corresponds to a time H in FIG. 4, this means that the fault is located on the supply side of circuit breaker 4₁, and that it is still present. The control unit 60 determines that the fault current threshold I2 is different from a final fault current threshold I_{f} and the device 10 performs step S116, calculating the tripping energy E_{d2} and comparing it with the tripping threshold Eₜₕ₂. The tripping energy E_{d2} is shown in dotted lines in FIGS. 3 and 4 on the energy graph E_{d}.

When the tripping energy E_{d2} is greater than or equal to the energy threshold Eₜₕ₂, steps S118, S120 and S122 are performed successively. As the circuit breaker 4₃ is connected immediately upstream of the circuit breaker 4₂, the processing module 62 then performs a third iteration of steps S112 to S122, using the tripping current threshold Is of the circuit breaker 4₃ and, if necessary, calculating the tripping energy E_{d3} and using the tripping threshold Eₜₕ₃, the maximum Iₘₐₓ₃ and minimum Iₘᵢₙ₃ currents and the reclosing time Tᵣ₃.

In the example shown in FIGS. 3 and 4, during the third iteration of step S114 the intensity I measured by the current sensor 52 is strictly greater than the fault current threshold Is of the circuit breaker 4₃, corresponding to a time L in FIG. 3. The fault is therefore located upstream of the circuit breaker 4₂ and is still present. The device 10 therefore performs steps S115, S320 and S118 to S122. The tripping energy E_{d3} is shown as a solid line in FIG. 3 on the energy graph E_{d}. FIG. 5 shows the control method for device 10, where Iₓ, E_{dx}, Eₜₕₓ and Tᵣₓ are respectively the fault current, tripping energy, tripping threshold, and reclosing time for iteration x, where x is 1, 2 or 3.

In a variant not shown, the installation 1 comprises more than three circuit breakers. In such a case, steps S112 to S122 continue to be iterated as long as circuit breakers are connected immediately upstream of the circuit breaker which tripped last.

When the third iteration has been performed, following step S122, the processing module 62 then performs step S112 in which the processing module 62 determines whether the test duration T₁, measured from the time at which the reclosing time Tᵣ₃ has elapsed, corresponding to a time P, has elapsed.

If the test duration T₁ has not elapsed, the processing module 62 detects in step S114 whether the intensity I of the current as measured by the current sensor 52 is strictly greater than the fault current threshold I₂, in other words, whether the short-circuit is still present.

If the test duration T₁ has elapsed without the intensity I as measured by the current sensor 52 having become strictly greater than the final fault current threshold Tr, then the process is restarted and step S102 is performed again.

If the intensity I of the current as measured by the current sensor 52 is less than or equal to the final fault current threshold I_{f} of the circuit breaker 4₂, the processing module 62 performs step S112 again, and an iterative process is then implemented.

If the intensity I measured by the current sensor 52 is strictly greater than the final fault current threshold I_{f}, which corresponds to a time Q in FIG. 4, this means that the fault is located between the circuit breaker 4₃ and the device 10, and that it is still present. In step S115, the control unit 60 determines that the fault current threshold used in the previous step S114 is equal to the final fault current threshold I_{f}.

The cell control module 66 then performs a step S138, in which it controls all the switching modules, in this case module 32, to enter an off-configuration. The current is thus interrupted by the device 10.

Optionally, once the intensity I of the current has become zero following step S138, the disconnector control module 68 controls the disconnectors 23 and 24 to enter the off-configuration, in order to galvanically isolate the device 10.

In a variant not shown, the final fault current threshold I_{f} is equal to the fault current threshold I₃. In this case, in step S115, the control unit 60 determines the number of times the same fault threshold is used and only performs step S138 if this number is greater than one.

Advantageously, if during step S112, the test duration has elapsed without the current threshold I₁, I₂, I₃ or If having passed, the control unit 60 performs a step S140, during which it compares the intensity I with the transient fault current threshold I₀. If the intensity is strictly greater than the transient fault threshold I₀, then the cell control module 66 performs step S138. Otherwise, the process is restarted, and step S102 is performed again.

Alternatively, not shown, during step S140, the control unit 60 compares the derivative I′ of the intensity I as a function of time t with a predetermined fault derivative threshold, or else determines whether a combination of conditions on the intensity I and its derivative I′ are fulfilled, for example the intensity I is strictly greater than the transient fault current threshold I₀ and the derivative of the intensity I is strictly greater than the fault derivative threshold. In this case, the cell control module 66 performs step S138 if the derivative I′ is strictly greater than the predetermined fault derivative threshold or if the conditions regarding the intensity I and its derivative I′ are met.

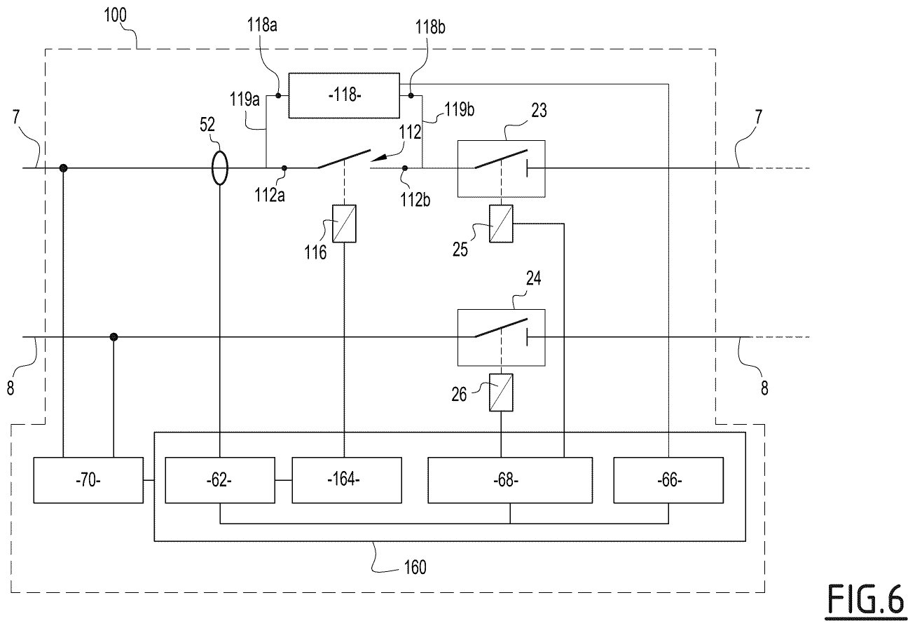

FIG. 6 shows an electrical installation 1, which differs from the electrical installation in FIG. 1 in that its device 100 replaces the device 10. The components of device 100 that are identical to those of device 10 or are identified in FIG. 6 by the same reference signs are similar, at least functionally, to those of device 10 and are not described in detail.

The circuit breakers 4₁, 4₂, 4₃ are also each associated with the minimum intensity, Iₘᵢₙ₁, Iₘᵢₙ₂ and Iₘᵢₙ₃ respectively, which is equal to the respective fault current thresholds I₁, I₂, I₃, and with a maximum intensity, Iₘₐₓ₁, Iₘₐₓ₂ and Iₘₐₓ₃. respectively.

The device 100 is a hybrid circuit breaker, and comprises a mechanical switch 112, also known as a bypass switch, or fast mechanical switch (FMS). The mechanical switch 112 is connected in series with the phase conductor 7, via an input 112a and an output 112b, and is configured to switch between a closed configuration, wherein it conducts the current flowing between the source 3 and the load 5, and an open configuration, wherein it does not conduct the current. In FIG. 6, the mechanical switch 112 is shown in the open configuration. Advantageously, the device 100 comprises an actuator 116 which, when activated, switches the mechanical switch 112 to the open configuration.

The device 100 comprises an interruption cell 118, connected in parallel with the mechanical switch 112, such that the input 112a and output 112b of the mechanical switch 112 are connected respectively to an input 118a and an output 118b of the interruption cell 118. More specifically, the input 112a of the mechanical switch 112 and the input 118a of the interruption cell 118 are connected by an electrical link 119a, which is non-interruptible, and the output 112b of the mechanical switch 112 is connected to the output 118b of the interruption cell 118 by an electrical link 119b, which is also non-interruptible. In other words, the electrical links 119a and 119b are each an electrical cable or wire; none of the electrical links 119a and 119b comprise a switch or, more generally, a means of interrupting the electrical current. The interruption cell 118 is configured to allow or interrupt the current flowing through it, as explained later.

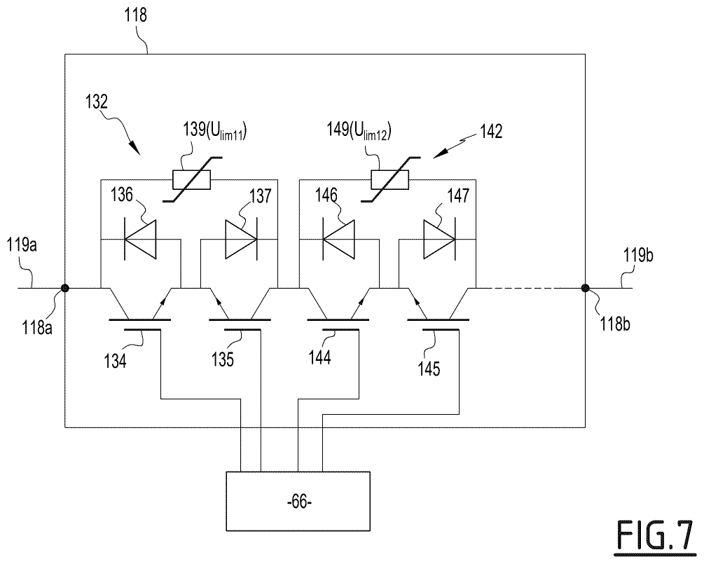

The interruption cell 118 comprises N switching modules, for example the interruption cell 118 comprises N=2 switching modules 132 and 142, as shown in FIG. 7. Alternatively, there are three or more switching modules, as symbolised by the dotted line in FIG. 7.

The switching modules 132 and 142 are connected in series to one another.

In the example shown in FIG. 5, the switching module 132 is similar, at least functionally, to the switching module 32 and as such comprises two transistors 134, 135 connected in series with opposite orientations, two diodes 136 and 137 respectively connected in parallel to the transistors 134 and 135 with opposite orientations, and a limiting element 139, having a limiting voltage Uₗᵢₘ₁₁. The transistors 144, 145 and diodes 146 and 147 of the switching module 142 are respectively similar, at least functionally, to the transistors 134, 135 and diodes 136 and 137 of the switching module 132. The switching module 142 comprises a limiting element 149, connected in parallel with an assembly formed by the transistors 144 and 145 and has a limiting voltage Uₗᵢₘ₁₂, which is different from the limiting voltage Uₗᵢₘ₁₁.

The limiting voltage Uₗᵢₘ₁₁ is, for example, equal to 0.5 times Uₛ and the limiting voltage Uₗᵢₘ₁₂ is, for example, equal to 1.5 times Uₛ.

In the off-configuration, the voltages across the switching modules 132 and 142 are the limiting voltage Uₗᵢₘ₁₁ and the limiting voltage Uₗᵢₘ₁₂ respectively.

The limiting voltages Uₗᵢₘ₁₁ and Uₗᵢₘ₁₂ form at least 2^{N}−1 levels, distinct from each other. Here, the number Np of levels is equal to Np-2^{N}−1, where N is the number of switching modules. The levels are formed by the limiting voltages Uₗᵢₘ₁₁ and Uₗᵢₘ₁₂ taken alone, or summed together. The list of levels obtained is shown in the table below. For N=2 switching modules, three distinct levels P1, P2, P3 are obtained, with 3=2²−1. Here, P1 is the level with the lowest value, equal to Uₗᵢₘ₁₁ which is worth 0.5Uₛ for example, P2 is higher than P1, and has a value equal to Uₗᵢₘ₁₂ which is worth 1.5Uₛ for example, and P3 is higher than P2, with a value equal to the sum of Uₗᵢₘ₁₁ and Uₗᵢₘ₁₂, for example 2Uₛ.

TABLE 1

| Level | Value |
|---|---|
| P1 | Uₗᵢₘ₁₁ |
| P2 | Uₗᵢₘ₁₂ |
| P3 | Uₗᵢₘ₁₁ + Uₗᵢₘ₁₂ |

The level P1 is also known as the limiting level. The level P2 is the lowest level above the nominal mains voltage Uₛ, and is called the clipping level Pe.

The control device 100 comprises a control unit 160, which differs from the control unit 60 in that it additionally comprises a mechanical switch control module 164.

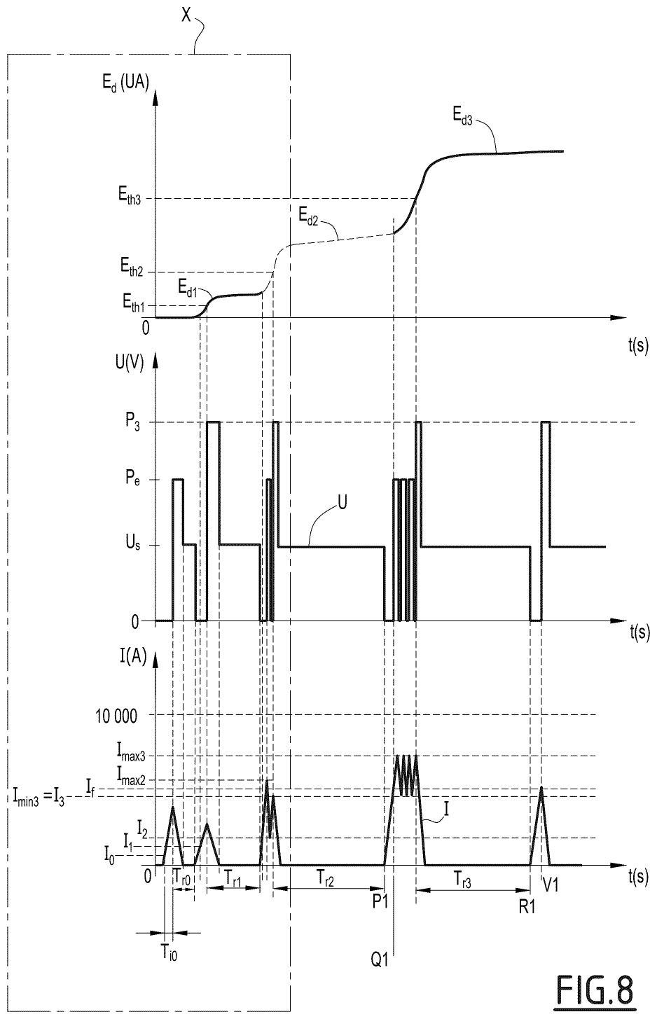

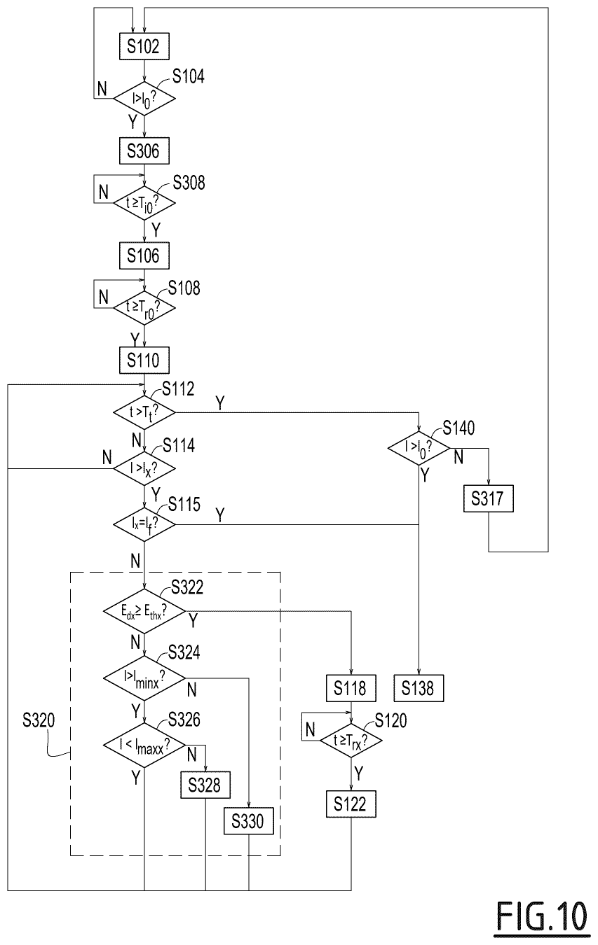

A method for controlling the device 100 will now be explained, with reference to FIGS. 8 and 10. The steps identical to the control method described above are referenced with the same reference signs.

Advantageously, the device 100 is initially in the armed configuration, i.e. the disconnectors 23 and 24 are in the closed configuration, the mechanical switch 112 is in the closed configuration, and the transistors 134, 135, 144 and 145 are conducting. Because its internal resistance is lower than that of the transistors 134, 135, 144 and 145, the mechanical switch 112 conducts all the electrical current flowing through the device 100. A voltage U across the device 100 is zero, or substantially zero.

The current sensor 52 measures the intensity I of the current flowing in the phase conductor 7 in step S102.

The control unit 160 receives the measurement of the intensity I of the current and detects, via the processing module 62, whether an electrical fault, corresponding to a potential short-circuit, is present between the source 3 and the load 5, in step S104. To do this, the processing module 62 compares the measured intensity I with a transient fault current threshold I₀. If the intensity I is less than or equal to the transient fault current threshold I₀, the current sensor 52 performs step S102 again and continues to measure the intensity I. An iterative process is then implemented.

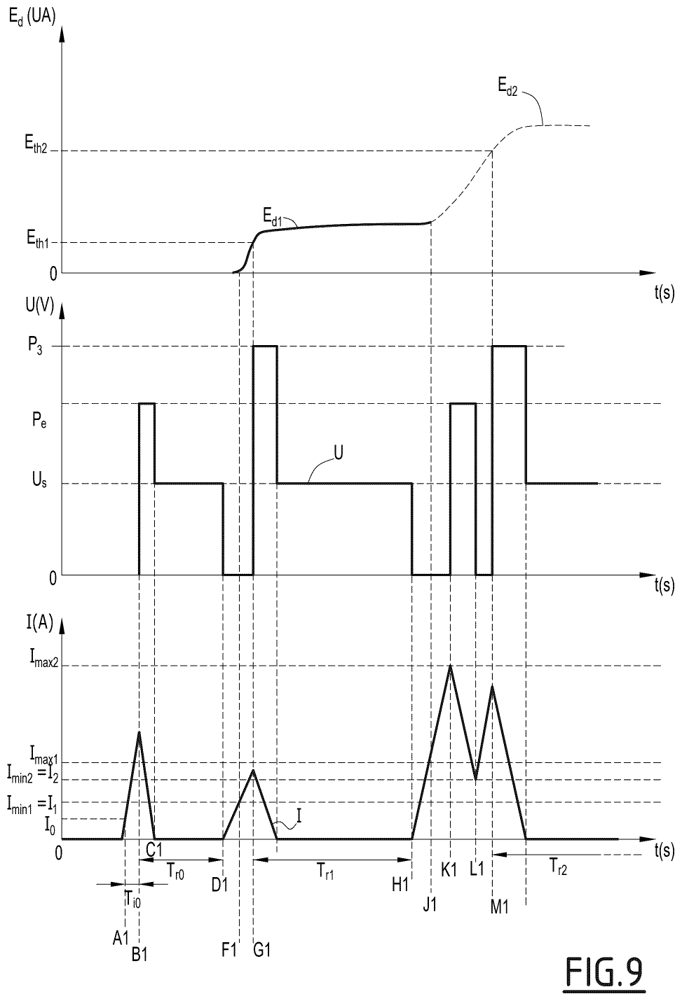

If the intensity I is strictly greater than the transient fault current threshold I₀, which corresponds to a time A1 in FIG. 9, then the mechanical switch control module 164 controls the mechanical switch 112 to change over to the open configuration in step S306.

When the mechanical switch 112 is in the open configuration, the electrical current is transferred from the mechanical switch 112 to the interruption cell 118, the transistors 134, 135, 144 and 145 being controlled to enter the on-configuration. However, opening the mechanical switch 112 generates an electric arc and ionisation of the medium between the contacts of the mechanical switch 112. This reduces the dielectric strength of the mechanical switch 112. Thus, before reducing or interrupting the current flowing between the source 3 and the load 5, it is necessary to wait for the dielectric strength of the mechanical switch 112 to be sufficiently restored. Otherwise there is a risk of the mechanical switch 112 flashing over, i.e. becoming conductive while in the open configuration, resulting in damage to the mechanical switch 112. The device 100 can then neither reduce nor interrupt the current. This waiting time corresponds to the isolation time Tio after which the dielectric strength of the mechanical switch 112 has increased sufficiently to become greater than the P3 level. The reclosing time Tᵣ₀ is advantageously predetermined and programmed by the manufacturer of the device 10.

Alternatively, in step S306, the cell control module 166 controls the switching module forming the highest level below the dielectric strength of the mechanical switch 112. In this way, the switching modules forming the levels P1 and then P2 are controlled to enter the off-configuration as soon as the dielectric strength exceeds those levels. This limits the increase in intensity I until the dielectric strength exceeds level P3.

The control unit 160 therefore waits for the isolation time Tio to elapse at step S308.

When the isolation time Tio has elapsed, which corresponds to a time B1 in FIG. 9, the cell control module 66 controls all the switching modules 132, 142 to enter the off-configuration in step S106. The voltage U becomes equal to the third level P3, in other words the clipping level Pe, and the intensity I decreases until it becomes zero, at time C1. When the intensity I has become zero, the voltage U becomes equal to the nominal mains voltage Uₛ.

The control unit 160 waits until the transient fault reclosing time Tᵣ₀, counted from time A1, has elapsed in step S108.

When the transient fault reclosing time Tᵣ₀ has elapsed, the cell control module 66 controls the modules 132 and 142 to enter the on-state, corresponding to the time D1 in FIG. 9 in step S110. The current therefore flows again between source 3 and load 5 and the voltage U becomes zero.

In a variant not shown, at time D1, the cell control module 66 controls the modules forming the limiting level P1 to enter the off-state and the others to enter the on-state.

The processing module 62 determines whether a test duration T₁, measured from time D1, has elapsed in step S112. If the test duration T₁ has not elapsed, the processing module 62 detects a short-circuit in step S114, if the intensity I of the current as measured by the current sensor 52 is less than, equal to or strictly greater than the fault current threshold I₁ of the circuit breaker 4₁, which is the circuit breaker in armed configuration furthest downstream in the series of circuit breakers 4.

Alternatively, the short-circuit is detected if the derivative I′ of the intensity I with respect to time t is strictly greater than a predetermined fault derivative threshold, or if a combination of conditions regarding the intensity I and its derivative l′ are met, for example the intensity I is strictly greater than the fault current threshold I₁ and the derivative I′ of the intensity I is strictly greater than the fault derivative threshold.

If the intensity I of the current as measured by the current sensor 52 is less than or equal to the fault current threshold I₁ of the circuit breaker 4₁, the processing module 62 performs step S112 again. An iterative process is then implemented.

If the test duration T₁ has elapsed without the intensity I having exceeded the fault current threshold I₁, then the control unit 60 performs step S140, in which it compares the intensity I with the transient fault current threshold I₀. If the intensity I is strictly greater than the transient fault threshold I₀, then the cell control module 66 performs step S138, wherein it controls all the switching modules, in this case modules 132 and 134, in the off-configuration. The current is thus interrupted by the device 10. Otherwise, the electrical fault detected in step S104 was a transient fault and has disappeared. The mechanical switch control module 164 then controls the mechanical switch 112 to switch to the off-configuration in step S317. The method is then restarted and the device 10 performs step S102 again.

If the intensity I of the current as measured by the current sensor 52 in step S114 is strictly greater than the fault current threshold I₁ of the circuit breaker 4₁, as represented at a time F1, then the control unit 160 determines that the fault current threshold I₁ used in step S114 is different from the final fault threshold in a step S115. The control unit 160 then estimates the tripping energy E_{d1} and compares it with the tripping energy threshold Eₜₕ₁ in step S116. Step S320 comprises a plurality of sub-steps S322 to S330.

In sub-step S322, the processing module 62 determines whether the tripping energy E_{d1}, shown as a solid line in FIGS. 8 and 9 on the energy graph E_{d}, is strictly less than the tripping energy threshold Eₜₕ₁, then the processing module 62 determines whether the intensity I as measured by the current sensor 52 is strictly greater than the minimum intensity Iₘᵢₙ₁, here equal to the fault current threshold I₁, in sub-step S324.

If the intensity I is strictly greater than the minimum intensity threshold Iₘᵢₙ₁, which is the case between times F1 and G1, the processing module 62 determines whether the intensity I is greater than or equal to the maximum intensity threshold Imax in step S326. If the intensity I is strictly less than the maximum intensity threshold Iₘₐₓ₁, the processing module 62 performs sub0step S112 again and an iterative process is then implemented.

If, during sub-step S322, the processing module 62 determines that the tripping energy E_{d1} is greater than or equal to the tripping energy threshold Eₜₕ₁, then the control unit performs steps S118 to S122 as described above for the first embodiment.

In particular, the cell control module 66 controls the module 32 to enter the off-configuration at step S118 corresponding to time G1, the processing module waits until the reclosing time Tᵣ₁, measured from time G1, has elapsed at step S120, and once the reclosing time Tᵣ₁ has elapsed, controls the modules 132 and 142 to enter the on-configuration at a time H1. Times G1 and H1 are shown in FIG. 9.

With the circuit breaker 4₂ being connected upstream of the circuit breaker 4₁, the processing module 62 performs a second iteration of steps S112 to S115, S320 and S118 to S122 using the trip current threshold I₂ of the circuit breaker 4₂ and, if necessary, by calculating the tripping energy E_{d2}, the maximum intensity Iₘₐₓ₂ and minimum intensity Iₘᵢₙ₂, using the tripping threshold Eₜₕ₂ and the reclosing time Tᵣ₂. If the test duration T₁ has not elapsed, the processing module 62 detects in step S114 whether the intensity I of the current as measured by the current sensor 52 is less than, equal to or strictly greater than the fault current threshold I₂ of the circuit breaker 4₂, in other words, whether the short-circuit is still present.

If the intensity I of the current as measured by the current sensor 52 is less than or equal to the fault current threshold I₂ of the circuit breaker 4₂, the processing module 62 performs step S112 again, and an iterative process is then implemented.

If the test duration T₁ has elapsed without the intensity I of the current as measured by the current sensor 52 having become strictly greater than the fault current threshold I₂ of the circuit breaker 4₂, then the control unit 60 performs step S140. If the intensity I is strictly greater than the transient fault threshold I₀, then the cell control module 66 performs step S138, otherwise, the mechanical switch control module 164 controls the mechanical switch 112 to enter the closed configuration in step S317, the process is restarted, and step S102 is performed again.

In the example shown in FIGS. 8 and 9, during step S114, the processing module 62 determines at time J1 that the intensity I is strictly greater than the fault current threshold I₂ of the circuit breaker 4₂. In step S115, the control unit 60 determines that the fault current threshold I₂ is different from the final fault current threshold I_{f}. The device 10 performs steps S320 and S118 to S122, using the tripping energy E_{d2}, the tripping energy threshold Eₜₕ₂, the reclosing time Tᵣ₂, the maximum intensity Iₘₐₓ₂ and the minimum intensity Iₘᵢₙ₂, the latter being equal to the fault current threshold I₂. The tripping energy E_{d2} is shown in dotted lines in FIGS. 8 and 9 on the energy graph E_{d}.

At a time K1, the processing module 62 performs sub-step S322 and determines that the tripping energy E_{d2} is strictly less than the energy threshold Eₜₕ₂. The processing module 62 then performs sub-step S324 and determines that the intensity I is strictly greater than the minimum intensity Iₘᵢₙ₂, and performs sub-step S326 and determines that the intensity I has reached the maximum intensity Iₘₐₓ₂, in other words, is greater than or equal to the maximum intensity Iₘₐₓ₂. The cell control module 66 then performs a sub-step S328 in which it controls the switching module 142 to enter the off-configuration at time K1, in other words, controls the switching modules whose limiting elements' limiting voltages form the clipping level Pe, in this case the switching module 142. Advantageously, in sub-step S328, the cell control module 66 controls the switching modules whose limiting elements' limiting voltages do not form the clipping level Pe to enter the on-configuration. The voltage U becomes equal to the clipping level Pe. This avoids excessive intensity I, which could damage the electrical installation 1.

Alternatively, the cell control module 66 controls each switching module 132, 142 to enter the off-configuration

As an alternative, not shown, in the case where the number N of steps is greater than three, the cell control module 66 controls the switching modules whose limiting elements' limiting voltages form a threshold greater than the nominal mains voltage Uₛ, so as to reduce the intensity I according to the formula:

$$T A ≅ 1 - \frac{U}{{U}_{s}}$$

with
TA is the rate of increase in intensity l;
U is the voltage across device 10; and
Uₛ the nominal mains voltage.

In practice, the voltages induced by the resistance of conductors 7 and 8 and by the fault are considered negligible, and the rate of increase TA is therefore considered to be equal to

$$1 - \frac{U}{{U}_{s}} .$$

The intensity decreases until a time L1 at which the intensity I becomes equal to or less than the minimum intensity Iₘᵢₙ₂. In sub-step S326, the processing module 62 therefore determines that the intensity I is less than or equal to the minimum intensity Iₘᵢₙ₂ and the control module 66 performs a sub-step S330, in which it controls the modules whose limiting elements' limiting voltages form the clipping level Pe, in this case the module 142, to enter the on-state. The intensity I increases again and the voltage U becomes zero. Sub-step S322 is then performed again and an iterative process is implemented. This ensures that the intensity I is high enough to ensure that the tripping energy E_{d2} continues to increase.

In a variant not shown, during sub-step S330, the cell control module 66 controls the modules forming the limiting level P1 to enter the off-state and the others to enter the on-state.

In a variant not shown, in sub-step S330, the cell control module 66 controls all the modules to enter the on-state.

At a time M1, the processing module 62 determines in step S322 that the tripping energy E_{d2} has reached the energy threshold Eₜₕ₂. The cell control module 66 then controls all of the switching modules 132, 142 to enter the off-configuration in step S118. Following step S118, the control unit 60 performs steps S120 to 122.

The processing module 62 waits for the reclosing time Tᵣ₂ to elapse in step S120 and controls the switching modules 132, 142 to enter the on-configuration in step S122.

The processing module 62 performs a third iteration of steps S112 to S115, S320 and S118 to S122 using the trip current threshold Is of the circuit breaker 4₃ and, if necessary, by calculating the tripping energy E_{d3}, the maximum intensity Iₘₐₓ₃ and minimum intensity Iₘᵢₙ₃, using the tripping threshold Eths and the reclosing time Tᵣ₃. If the test duration T₁ has elapsed without the intensity I of the current as measured by the current sensor 52 having become strictly greater than the fault current threshold I₂, the control unit 60 performs step S140. If the current is strictly greater than the transient fault threshold I₀, then the cell control module 66 performs step S138, otherwise step S317 is performed, in which the mechanical switch 112 is controlled to enter the closed configuration, the process is reset, and step S102 is performed again.

In the example shown in FIG. 8, the processing module 62 determines that the test duration T₁ has not elapsed, performs step S114 and detects at a time Q1 that the intensity I of the current as measured by the current sensor 52 is strictly greater than the fault current threshold I₃ of the circuit breaker 4₃, in other words that the short-circuit is still present.

The control unit 160 then performs steps S115, S320 and S118 to S122. The tripping energy E_{d3} is shown as a solid line in FIG. 8 on the energy graph E_{d}. FIG. 10 shows the method for controlling the device 100, where Iₓ, Iₘᵢₙₓ, Iₘₐₓₓ E_{dx}, Eₜₕₓ and Tᵣₓ are respectively the fault current, the minimum intensity, the maximum intensity, the tripping energy, the tripping threshold and the reclosing time for iteration x, where x is equal to 1, 2 or 3. In a variant not shown, the installation 1 comprises more than three circuit breakers and steps S112, to S115, S320 and S118 to S122 continue to be iterated as long as a circuit breaker is connected immediately upstream of the last tripped circuit breaker.

The processing module 62 performs step S112 again and determines whether the test duration T₁, measured from the time when the reclosing time Tᵣ₃ has elapsed, corresponding to time R1, has elapsed. If the test duration T₁ has not elapsed, the processing module 62 detects in step S114 whether the intensity I of the current as measured by the current sensor 52 is less than, equal to or strictly greater than the fault current threshold I₂, in other words, whether the short-circuit is still present.

If the intensity I of the current as measured by the current sensor 52 is less than or equal to the final fault current threshold I_{f} of the circuit breaker 4₂, the processing module 62 performs step S112 again, and an iterative process is then implemented.

If the test duration T₁ has elapsed without the intensity I of the current as measured by the current sensor 52 having become strictly greater than the final fault current threshold I₂, then the control unit 60 performs step S140. If the intensity is strictly greater than the transient fault threshold I₀, then the cell control module 66 performs step S138, otherwise, the mechanical switch 112 is controlled to enter the closed configuration in step S317, the method is restarted, and step S102 is performed again.

If the intensity I of the current as measured by the current sensor 52 is strictly greater than the final fault current threshold I_{f}, which corresponds to time V1 in FIG. 4, this means that the fault is located upstream of the circuit breaker 4₃ and that it is still present. The control unit determines in step S115 that the current threshold used in the previous step S114 is equal to the final fault current threshold I_{f}. The cell control module 66 then performs step S138, in which it controls all the switching modules, in this case modules 132 and 134, to enter the off-configuration and interrupts the current in the device 10.

Optionally, once the intensity I of the current has become zero following step S138, the disconnector control module 68 controls the disconnectors 23 and 24 to enter the off-configuration, in order to galvanically isolate the device 10.

Alternatively, not shown, the source 3 and the load 5 are connected together by a plurality of phase conductors, for example three. In this case, the device 10 advantageously comprises, for each phase conductor, a mechanical switch and an interruption cell connected in parallel with the mechanical switch.

Optionally, a mechanical switch is connected to the neutral conductor, with an interruption cell connected in parallel with the mechanical switch.

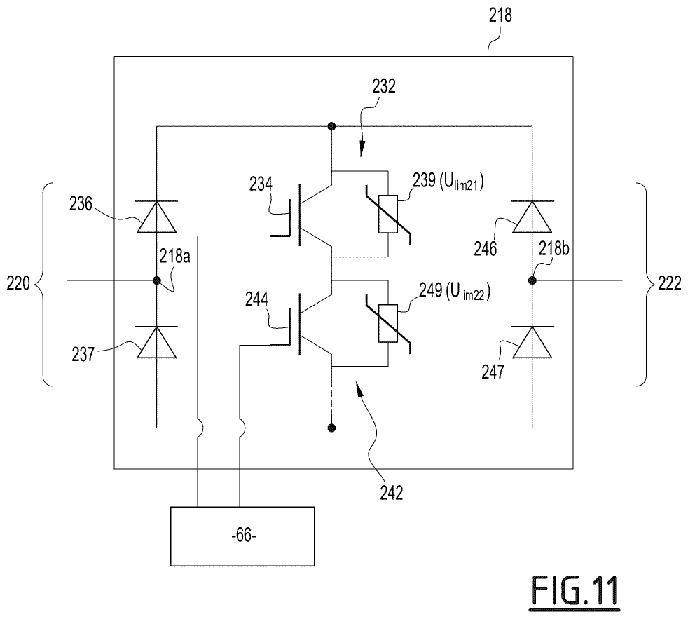

FIG. 11 is a diagram of an interruption cell 218 in accordance with a third embodiment of the invention, as an alternative to the interruption cell 18 or 118.

When the interruption cell 218 is integrated into the device 10, it replaces the interruption cell 18 and is connected in series to the phase conductor 7 via an input 218a and an output 218b.

When the interruption cell 218 is integrated into a device 100, the interruption cell 218 replaces the interruption cell 118. In this case, the interruption cell 218 is, in a similar way to the interruption cell 118, connected in parallel with the mechanical switch 112, such that the input 112a and the output 112b of the mechanical switch 112 are connected respectively to the input 218a and the output 218b of the interruption cell 218. More specifically, the input 112a of the mechanical switch 112 and the input 218a of the interruption cell 218 are connected by the electrical link 119a, which is non-interruptible, and the output 112b of the mechanical switch 112 is connected to the output 118b of the interruption cell 218 by the electrical link 119b, which is also non-interruptible.

The interruption cell 218 comprises two rectifying branches 220 and 222. Each rectifying branch 220 and 222 comprises two diodes, 236 and 237 respectively for the rectifying branch 220, and 246 and 247 for the rectifying branch 222. The diodes 236 and 237 are connected to each other in series with opposite orientations, i.e. the diodes 236 and 237 are connected in series and never conduct current at the same time. The same applies to the diodes 246 and 247.

The input 218a and output 218b of the interruption cell 218 correspond respectively to the midpoint of the rectifying branch 220, between the diodes 236 and 237, and to the midpoint of the rectifying branch 222, between the diodes 246 and 247. In this way, the interruption cell 218 is connected in parallel with the mechanical switch 112 via the midpoint of each rectifying branch 220 and 222.

The interruption cell 218 comprises two interruption modules 232 and 242. The interruption modules 232 and 242 are connected in parallel with the rectifying branches 220 and 222 and in series with each other. Alternatively, the interruption cell 218 comprises more than two interruption modules, connected in series with the interruption module 242 and in parallel with the branches 220 and 222, as symbolised by the dotted line in FIG. 11.

The interruption modules 232 and 242 respectively comprise a switchable semiconductor element, in this case a transistor 234 and 244, and a voltage limiting element 239 and 249. The voltage-limiting element 239 is connected in parallel with the transistor 234 and the voltage-limiting element 249 is connected in parallel with the transistor 244. The voltage limiting elements 239 and 249 are similar, at least functionally, to the voltage limiting elements 139 and 149 and have a limiting voltage Uₗᵢₘ₂₁ and Uₗᵢₘ₂₂ respectively. The limiting voltage Uₗᵢₘ₂₁ is different from the limiting voltage Uₗᵢₘ₂₂ and these voltages form three steps, similar to the limiting voltages Uₗᵢₘ₁₁ and Uₗᵢₘ₁₂.

The interruption cell 218 is configured to receive alternating current and convert it to direct current using the diodes 236, 237, 246 and 247, so that direct current flows through the switching modules 232 and 242. The arrangement of diodes 236, 237, 246 and 247 limits the number of diodes in the interruption cell 218 to four. Thus, even when the interruption cell 218 comprises more than two switching modules, only the four diodes 236, 237, 246 and 247 are required for their operation, thus limiting the number of diodes required relative to the interruption cell 118.

The method for controlling the protection device 10 comprising an interruption cell 218 and the method for controlling the protection device 100 comprising an interruption cell 218 are similar to those described respectively for the protection device 10 comprising the interruption cell 18 and for the protection device 100 comprising the interruption cell 118 and are not again described in detail.

Advantageously, the control methods described and shown in FIGS. 3 to 5 and 8 to 10 last 10 ms or less.

Alternatively, applicable to all embodiments, in the event that one of the circuit breakers in the series of circuit breakers 4 is a static or hybrid circuit breaker, an isolation time is associated with this circuit breaker, corresponding to a time required to trip the circuit breaker.

Alternatively, applicable to all embodiments, each circuit breaker in the series of circuit breakers 4 is associated with a test duration, which may be different for one or more of the circuit breakers 4₁, 4₂, 4₃. In this case, the test duration used is updated in step S126, in addition to the values of the fault current threshold, the reclosing time and, if applicable, the maximum and minimum intensities.

Alternatively, applicable to all embodiments, the device 10 is arranged upstream of a medium-voltage to low-voltage transformer, and the series of circuit breakers 4 is downstream of the medium-voltage to low-voltage transformer.

In an alternative applicable to all embodiments (not shown), the electrical installation 1 does not comprise a neutral conductor 8.

Any feature described for one embodiment or variant in the foregoing may be implemented for the other embodiments and variants described above, insofar as technically feasible.

1. A method of controlling an electrical protection device configured to be connected between a source and a series of circuit breakers, the electrical protection device comprising:
an interruption cell, comprising at least one switching module, each switching module comprising:
at least one semiconductor element; and
a limiting element, connected in parallel with the at least one semiconductor element, the limiting element having a limiting voltage, the limiting voltage or voltages, alone and/or summed together, forming one or a plurality of distinct levels,
each switching module being configured to switch between an on-configuration, wherein a current flowing between the source and the series of circuit breakers flows through the or one of the semiconductor elements, and an off-configuration, wherein if the current flows through the switching module, the current flows through the limiting element;
a current sensor, configured to measure an intensity and/or derivative of the current;
a control unit comprising a processing module and a cell control module, configured to control each switching module in the on-configuration and in the off-configuration,
each circuit breaker of the series being configured to switch between an armed configuration and a tripped configuration, each circuit-breaker in the series being associated with a fault current threshold, a tripping energy threshold and a reclosing time, the circuit-breakers being connected so as to be in series with one another and arranged from upstream to downstream in decreasing order of their respective fault current threshold:
the control method comprising at least the following steps:
a) measuring the intensity and/or the derivative of the intensity (I) as a function of time using the current sensor;
b) detecting an electrical fault of the short-circuit type by the processing module, if the intensity measured by the current sensor is strictly greater than the fault current threshold and/or the derivative measured by the current sensor is strictly greater than a fault derivative threshold of a given circuit breaker, the given circuit breaker being the circuit breaker in armed configuration furthest downstream in the series of circuit breakers
c) when an electrical fault of the short-circuit type is detected, waiting until the tripping energy becomes greater than or equal to a tripping energy threshold of the given circuit-breaker;
d) when the tripping energy is greater than or equal to the tripping energy threshold of the given circuit breaker, controlling each switching module to enter the off-configuration by the cell control module;
e) when the reclosing time of the given circuit breaker has elapsed, the given circuit breaker having switched to the tripped configuration, controlling each switching module to enter the on-configuration, whereas each switching module was controlled to enter the off-configuration in step d);
f) if a circuit-breaker is connected immediately upstream of the given circuit-breaker, if a test duration has not elapsed and if a short-circuit is detected, the fault current threshold, the tripping energy threshold and the reclosing time being those of the circuit-breaker in the armed configuration immediately upstream of the given circuit-breaker, carrying out steps c) to f) again; and
g) if no circuit-breaker is connected immediately upstream of the given circuit-breaker, if the test duration has not elapsed and if a short-circuit is detected, with the fault current threshold equal to a final fault current threshold, controlling each switching module to enter the off-configuration.

2. The control method according to claim 1, wherein the control method further comprises the following successive steps:
h) the processing module detecting an electrical fault of the short-circuit type, if the intensity measured by the current sensor is strictly greater than a transient fault current threshold and/or the derivative measured by the current sensor in step a) is strictly greater than a fault derivative threshold;
i) the cell control module controlling each switching module to enter the off-configuration if an electrical fault is detected in step h);
j) when a reclosing time of the transient fault has elapsed, controlling each switching module to enter the on-configuration; and
k) if the test duration has not elapsed, carrying out steps b) to g), the given circuit-breaker being the circuit-breaker in the armed configuration that is connected furthest downstream.

3. The control method according to claim 2, wherein the control method further comprises the following step:
l) when an electrical fault of the short-circuit type is detected by the processing module in step h), controlling a mechanical switch, connected in parallel with the interruption cell, to enter an open configuration, the mechanical switch being configured to switch between a closed configuration, wherein the mechanical switch conducts the current, and an open configuration, wherein the mechanical switch does not conduct the current, by a mechanical switch control module included in the control unit,
and wherein step i) is performed when a dielectric strength of the mechanical switch is greater than a sum of the limiting voltage of the limiting element of each switching module.

4. The control method according to claim 3, wherein if the test duration has elapsed and if a short-circuit is not detected, controlling the mechanical switch to enter the closed configuration.

5. The control method according to claim 2, further comprising the following step:
m) if the test duration has elapsed, and the intensity is strictly greater than a transient fault current threshold and/or the derivative measured by the current sensor is strictly greater than a fault derivative threshold, controlling each switching module to enter the off-configuration.

6. The control method according to claim 1, wherein each circuit breaker is furthermore associated with a minimum intensity threshold threshold and a maximum intensity threshold and wherein step c) further comprises the following sub-steps:
c1) when an electrical fault of the short-circuit type is detected by the processing module in step b), the tripping energy is less than or equal to the tripping energy threshold of the given circuit breaker, and the intensity measured by the current sensor is less than or equal to the minimum intensity threshold, the cell control module controls the one or more switching modules whose limiting elements' limiting voltages form a clipping level to enter the on-configuration, the clipping level being the lowest level above a nominal mains voltage; and
c2) when an electrical fault of the short-circuit type is detected by the processing module in step b), the tripping energy is less than or equal to the tripping energy threshold of the given circuit breaker, and the intensity measured by the current sensor reaches the maximum intensity threshold, the cell control module controls the one or more switching modules whose limiting elements' limiting voltages form the clipping level to enter the off-configuration.

7. The control method according to claim 6, wherein the electrical protection device comprises a plurality of switching modules, connected to each other, and wherein sub-step c2) further comprises the cell control module controlling those switching modules whose limiting elements' limiting voltages do not form the clipping level to enter an on-configuration.

8. An electrical protection device configured to be connected between a source and a series of circuit breakers, each circuit breaker of the series being configured to switch between an armed configuration and a tripped configuration, each circuit breaker of the series being associated with a fault current threshold, a tripping energy threshold and a reclosing time, the circuit-breakers being configured to be connected in series with one another and arranged from upstream to downstream in decreasing order of their respective fault current threshold, the electrical protection device comprising:
an interruption cell, comprising at least one switching module, each switching module comprising:
at least one semiconductor element; and
a limiting element, connected in parallel with the at least one semiconductor element, the limiting element having a limiting voltage, the limiting voltage or voltages, alone and/or summed together, forming one or a plurality of distinct levels,
each switching module being configured to switch between an on-configuration, wherein a current flowing between the source and the series of circuit breakers flows through the or one of the semiconductor elements, and an off-configuration, wherein if the current flows through the switching module, it flows through the limiting element;
a current sensor, configured to measure an intensity of the current and/or a derivative of the current;
a control unit comprising:
a processing module configured to detect an electrical fault of the short-circuit type as a function of the intensity and/or derivative measured by the current sensor; and
a cell control module, configured to control each switching module to enter the on-configuration and the off-configuration,
the electrical protection device being configured to implement the control method according to claim 1.

9. The electrical protection device according to claim 8, comprising a single switching module, the limiting voltage of the voltage limiting element of the switching module then forming the clipping level.

10. An electrical installation, comprising a source, a load, a series of circuit breakers, connected between the source and the load, each circuit breaker of the series being configured to switch between an armed configuration and a tripped configuration, each circuit breaker of the series being associated with a fault current threshold, a tripping energy threshold and a reclosing time, the circuit-breakers being connected in series with one another and arranged from upstream to downstream in decreasing order of their respective fault current threshold, and electrical protection device according to claim 8, connected between the source and the series of circuit breakers.
